(19) United States
(12) Patent Application Publication
(10) Pub. No.: US 2023/0350722 A1
(43) Pub. Date: Nov. 2, 2023

(54) APPARATUSES AND METHODS FOR DETERMINING AN INTERDEPENDENCY BETWEEN RESOURCES OF A COMPUTING SYSTEM

(71) Applicant: Intel Corporation, Santa Clara, CA (US)

(72) Inventor: Rajesh POORNACHANDRAN, Portland, OR (US)

(21) Appl. No.: 18/145,057

(22) Filed: Dec. 22, 2022

(51) Int. Cl. G06F 9/50; G06F 9/48; G06F 9/52

(52) U.S. Cl. CPC G06F 9/5038; G06F 9/4881; G06F 9/52

(57) ABSTRACT

An apparatus is proposed, the apparatus comprising interface circuitry, machine-readable instructions, and processing circuitry to execute the machine-readable instructions to receive a request to execute a task on a computing system, receive a service-level agreement, SLA, indicating at least one of a desired computing performance and a desired computing power for an execution of the task by the computing system, determine an interdependency between at least two resources of the computing system required for the execution of the task based on the SLA and schedule the execution of the task based on the interdependency between the at least two resources.

### BACKGROUND

The power management of resources of a computing system is conventionally based on static resource settings which aim at maximum performance at maximum utilization. Hence, there may be a demand for improved power management.

### BRIEF DESCRIPTION OF THE FIGURES

Some examples of apparatuses and/or methods will be described in the following by way of example only, and with reference to the accompanying figures, in which

FIGS. 1a and 1b illustrate an example of an apparatus;

FIG. 2 illustrates an example of an architecture of a computing system;

FIG. 3 illustrates an example of a method for exploring and configuring resources of a computing system;

FIG. 4 illustrates an example of a method for selecting a resource combination among a plurality of resource combinations based on a respective interdependency;

FIGS. 5a and 5b illustrate another example of an apparatus;

FIG. 6 illustrates an example of a method; and

FIG. 7 illustrates another example of a method.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

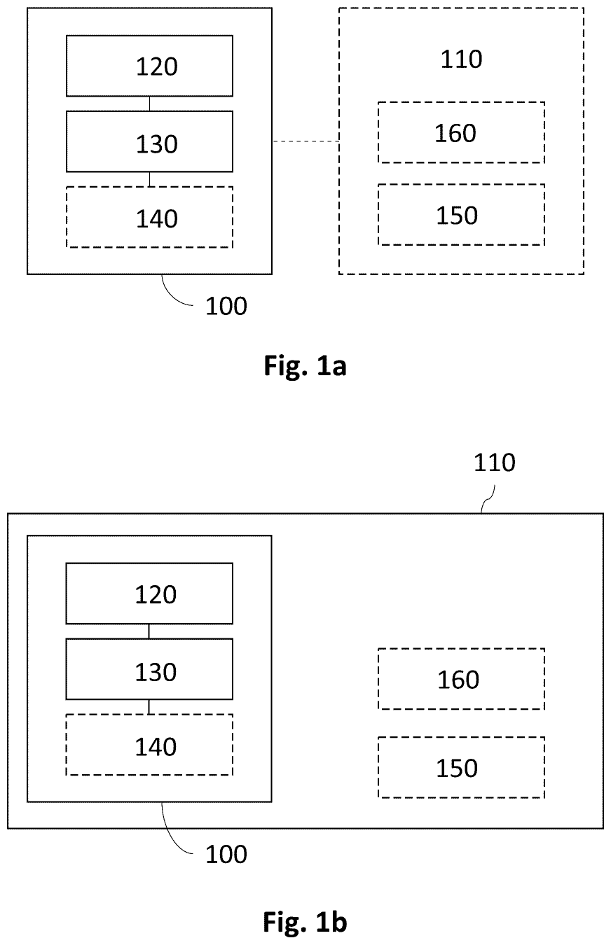

FIG. 1a shows a block diagram of an example of an apparatus 100 or device 100 communicatively coupled to a computer system 110. FIG. 1b shows a block diagram of an example of a computer system 110 comprising an apparatus 100 or device 100.

The apparatus 100 comprises circuitry that is configured to provide the functionality of the apparatus 100. For example, the apparatus 100 of FIGS. 1a and 1b comprises interface circuitry 120, processing circuitry 130 and (optional) storage circuitry 140. For example, the processing circuitry 130 may be coupled with the interface circuitry 120 and with the storage circuitry 140.

For example, the processing circuitry 130 may be configured to provide the functionality of the apparatus 100, in conjunction with the interface circuitry 120 (for exchanging information, e.g., with other components inside or outside the computer system 110) and the storage circuitry 140 (for storing information, such as machine-readable instructions).

Likewise, the device 100 may comprise means that is/are configured to provide the functionality of the device 100.

The components of the device 100 are defined as component means, which may correspond to, or implemented by, the respective structural components of the apparatus 100. For example, the device 100 of FIGS. 1a and 1b comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

The interface circuitry 120 is configured to receive a request to execute a task on the computing system 110. The task may be any part of a workload, a virtual thread, a process, a job or a data flow. The interface circuitry 120 may receive the request from the computing system 110 itself or from an external device (e.g., a user device) via any communicative coupling (wired or wireless).

The interface circuitry 120 is further configured to receive a service-level agreement, SLA, indicating at least one of a desired computing performance and a desired computing power for an execution of the task by the computing system 110. The interface circuitry 120 may, e.g., receive the requirement likewise from the computing system 110 or from an external device via any communicative coupling. In other examples, the processing circuitry 130 may determine the SLA from specifications of the task or by negotiations with the task. The SLA may be any agreement about a service provided by the computing system 110 (e.g., the execution of the task) between two or more parties, e.g., between a service provider (providing the service on the computing system 110) and a user (customer) sending the request.

The SLA may be, for example, a costumer-based, service-based or multilevel-based SLA. The apparatus 100 may in some examples further exhibit the capability (e.g., on demand of the (cloud) service provider) to expose a specific application SLO (service-level objective), e.g., a VM (virtual machine) selection, to a user for negotiating the SLA.

The desired computing performance may, for instance, be indicated by at least one of a response time, a throughput, a bandwidth, a latency, an efficiency, a resource utilization and a time for completion of the task. The desired computing power may refer to a physical (electrical) power, e.g., measured in Watt.

The processing circuitry 130 is configured to determine an interdependency between at least two resources 150, 160 of the computing system 110 required for the execution of the task based on the SLA and schedule the execution of the task based on the interdependency between the at least two resources 150, 160.

Such resources 150, 160 may be any physical or virtual (system) resource of limited availability within the computing system 110. The computing system 110 may, for instance, exhibit a heterogenous architecture comprising resources of different types. For instance, the at least two resources 150, 160 may comprise at least one of a central processing unit (CPU), a graphics processing unit (GPU), a field-programmable gate array (FPGA), and an accelerator. For instance, the resources 150, 160 may be XPUs (X processing unit, i.e., a processing unit of any architecture such as a CPU or a non-CPU processing unit, e.g., GPU, FPGA, etc.). In some examples, the at least two resources 150, 160 are processing units exhibiting different architectures. For instance, resource 150 may be a GPU while resource 160 may be an FPGA. Any other combination than the latter may be considered likewise. In some examples, at least one of the resources 150, 160 may be an uncore resource, i.e., resources that are not located in a processing core of the computing system 110.

The interdependency may be any dependency of one of the resources 150, 160 on the other and/or vice versa for executing the task. The interdependency may result from at least one of specifications of the task and the SLA. For instance, the interdependency may indicate which resource is needed to which extent at which stage of the task execution and which triggers (e.g., completion of a certain part of the task by one of the resources 150, 160) are necessary from one of the resources 150, 160 to proceed with an execution by the other resource. For instance, the SLA may indicate a desired efficiency for executing the task, the apparatus 100 may determine the interdependency between the resources 150, 160 such that the desired efficiency or a high QoS according to the SLA can be achieved.

The scheduling may be set accordingly, e.g., such that the resources 150, 160 execute the task as indicated by the interdependency. For instance, the processing circuitry 130 (e.g., a scheduler) may assign the resources 150, 160 to the execution of the task in a manner defined by the interdependency. For instance, the interdependency may be mapped to a schedule (e.g., a timeline of access, use and release of resources) and/or a configuration of the resources 150, 160 which may then be enforced by a resource control of the computing system 110. For scheduling execution of the task, the processing circuitry 130 may perform any scheduling technique, such as priority, multilevel, round-robin, pre-emptive and/or cooperative scheduling.

For instance, the apparatus 100 may provide a configuration module. The configuration module may represent an interface to provide a specific QoS profile which can be used to define an SLA, e.g., performance at 20%/30%/50% utilization of cores (resources 150, 160) or utilization across all cores, QUAD memory bandwidth, system power capped at 1 kW (kilowatt), maximum thermal temperature (TjMax) for XPU to be at 79°. The QoS profile may be specified, e.g., via BIOS (basic input output system) or via MSR (model-specific register) in combination with a mailbox scheme across a system supply chain state (manufacturing, provisioning, integration and validation). The latter mailbox scheme may provide the possibility to exchange mailbox commands for additional data along with MSR. The configuration module may generate the specific QoS profile mapping to the specific XPU under consideration, e.g., CPU identifier: top-bin in 40/56C XCC (name of CPU series); GPU identifier: 1 tile configuration of ATS (name of GPU series) or PVC (name of GPU series) at 75 watt or 4 tile configuration of GPU at 300 watt, with or without CXL support. The configuration module may enable the capability (exposed by cloud fleet manager) to specify XPU QoS in terms of utilization metric, power caps/constraints, latency/bandwidth, datatype precision/acceleration support via platform BMC (Baseboard Management Controller).

Conventional resource and power management of computing systems may focus as by default settings on achieving max performance at max utilization of resources. Conventional systems may provide completely static and heuristic based hard-coded values in its power management control unit. For instance, uncore frequency levels (knobs) may be statically defined in a mapping table (e.g., mapping from active idle utilization to uncore frequency level). The frequency level may be selected from the mapping table by a threshold utilization point.

By contrast, the apparatus 100 may determine an XPU interdependency (e.g., as flow graph) for a given SLA (model architecture) aiming at a high power and performance profile meeting specific QoS demands. For instance, the apparatus 100 may consider a customer deployment model which is, e.g., based on 20 to 50% utilization of resources for effective TCO (total cost of ownership). The apparatus 100 may provide a platform-level tuning of resources for compliance with user expectation (SLA), especially in heterogenous computing environments. The apparatus 100 may provide a QoS (quality of service) focused sustainable power management by providing the possibility to dynamic and configurable power control. The apparatus 100 may therefore provide the possibility to meet user expectation (indicated by the SLA) regarding the out-of-box computing performance and performance per Watt. The apparatus 100 may enable QoS or auto-tunable power management based on dynamic workload (task) needs which may scale beyond a CPU socket of the computing system 110 to the platform XPUs, e.g., across SKUs (stock keeping unit, i.e., different processing architectures or generations) which is not focused on top of the stack SKU bin only.

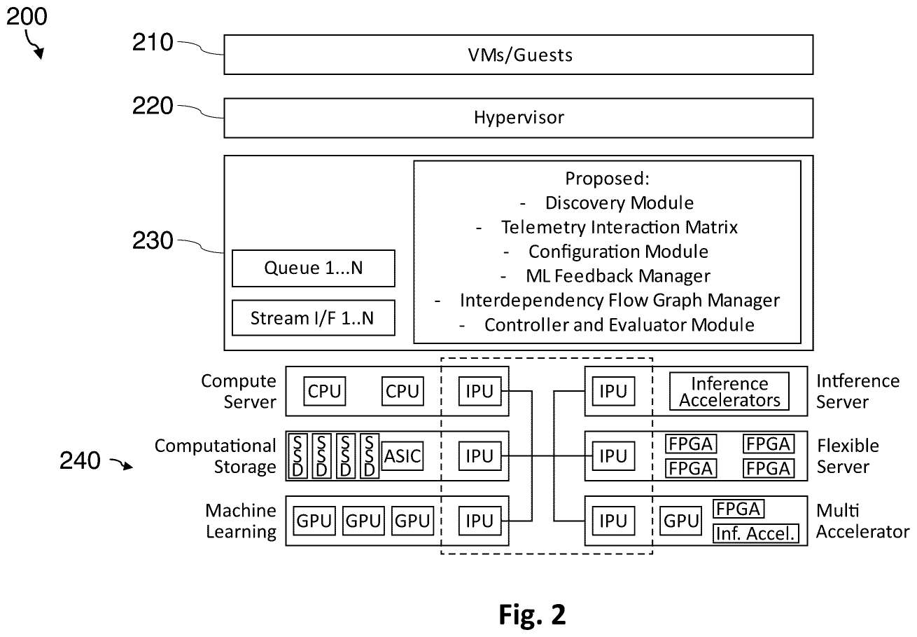

An example of an architecture 200 of the computing system 110 is illustrated by FIG. 2. The architecture 200 comprises a VM/Guest layer 210 and a hypervisor layer 220. Below the hypervisor layer 220, an apparatus 230 as described herein, such as apparatus 100, is implemented. The apparatus 230 comprises a discovery module, e.g., to determine a configuration of the computing system 110, a telemetry interaction matrix, e.g., to estimate a QoS parameter of resources of the computing system 110, a configuration module, e.g., to specify an SLA for a task (e.g., queue or stream), an machine learning feedback manager, e.g., to improve selection of the resources and their settings for achieving the objective specified by the SLA, an interdependency flow graph manager, e.g., to determine an interdependency between resources of the computing system 110, a controller and evaluator module, e.g., to monitor the execution of the task in terms of achieved QoS.

The architecture 200 also shows an example of a configuration 240 of the computing system 110. The configuration 240 comprises CPUs, SSDs (solid state drives), an ASIC (application-specific integrated circuit), GPUs, FPGAs, and accelerators in a specific arrangement, distributed to six hardware units (servers). The hardware units are interconnected and their interconnections are controlled by IPUs (infrastructure processing units).

In the following, examples of how the interdependency may be determined are described in more detail:

In some examples, the processing circuitry 130 is configured to determine the interdependency between the at least two resources 150, 160 by determining a desired respective utilization of each of the at least two resources 150, 160 based on the SLA. Utilization may refer to a usage of the resources 150, 160 or the amount of work handled by the resources 150, 160. The desired utilization may be, e.g., predefined by the SLA or may be determined from other parameters indicated by the SLA. The resource management (or scheduling) based on a predefined utilization may allow to move away from the conventional maximum utilization concept described above. Instead, the apparatus 100 may enable task-specific utilization guarantees.

Further, since the at least two resources 150, 160 will have to cooperate according to the interdependency in order to execute the task as scheduled, an interoperability may be relevant to consider. The processing circuitry 130 may, for instance, be configured to determine the interdependency between the at least two resources 150, 160 by determining the interoperability between the at least two resources 150, 160. For instance, interoperability may describe the capability of the resources 150, 160 to exchange data via a common set of exchange formats, to read and write the same file formats, or to use the same protocols.

Apart from processing resources, several non-processing resources may be needed for execution of the task. Depending on the task, such further resources may be a bottleneck for the overall computing performance. Therefore, it may be beneficial to consider such further resources for scheduling. The processing circuitry 130 may, for instance, be configured to determine the interdependency between the at least two resources 150, 160 by determining at least one further resource of the computing system 110 shared by the at least two resources 150, 160 required for the execution of the task. For instance, the processing circuitry 130 may be configured to determine the at least one further resource by determining at least one of a memory bandwidth and a network bandwidth shared by the at least two resources 150, 160.

Such a shared resource may be, e.g., shared LLC (last level cache), memory (bandwidth), UPI (ultra path interconnect), CXL (compute express link), PCIe (peripheral component interconnect express) (lane), a shared attach point to I/O (input/output), memory or cache. In some examples, the shared resource is at least one of a storing (memory or cache) or communication resource (network, link).

The above-mentioned triggers may be due to a data dependency between the at least two resources 150, 160. In some examples, the processing circuitry 130 is configured to determine the interdependency between the at least two resources 150, 160 by determining the data dependency between the at least two resources 150, 160. For instance, the processing circuitry 130 may be configured to determine the data dependency between the at least two resources 150, 160 by determining at least one of an availability of computing services of the computing system 110 and a call sequence of the task.

A concrete example of an interdependency (flow graph or matrix) is described by the following Function 1:

interdependency flow matrix=FUNC (XPU interaction matrix, XPU QoS, App SLO, ML feedback)

Function 1, where interdependency flow matrix is a specific form to represent the interdependency; FUNC is any, e.g., heuristically determined, function for describing a relationship between the interdependence and the variables in brackets; XPU interaction matrix is defined by Function 2 below; XPU QoS (defined by Function 4) refers to QoS-relevant attributes of the resources 150, 160 (XPUs); App SLO (defined by Function 5) is an SLO of the task (application); ML Feedback (defined by Function 6) is a machine learning feedback, e.g., based on past decisions.

interaction matrix=FUNC(XPU roster, XPU shared services, XPU interop, XPU flow graph, XPU power weightage matrix);

Function 2, where XPU roster refers to discovered resources (XPUs) available in a given platform(s) (computing system 110) under consideration, e.g., CPU, GPU, FPGA, (Smart) NIC (network interface card), etc.; XPU shared services refers to the shared platform ingredients (further resource) across the XPUs, e.g., DDR (double data rate) memory, CXL/PCIe interconnect, storage, NIC, etc.; XPU interop refers to the interoperability between the resources (XPUs) based on the workload (task) characteristics, e.g., for a specific task such as an artificial intelligence (AI) inference, an interoperability may be checked between resources of a NIC, a GPU and a CPU; XPU flow graph (defined by Function 3) refers to the data flow graph (data dependency) between the identified XPUs (using XPU Interop, XPU shared services as described below) and, optionally, between the XPUs and the further resources (e.g., interconnect and storage), e.g., a data flow from NIC to DDR memory may be processed by a CPU and shared with GPU for inferencing, then, the GPU inferred data may be sent to CPU to be forwarded to NIC; XPU power weightage matrix refers to a power weightage or power cap to be applied for specific XPUs based on an applications utilization metric (task-specific utilization of resources), e.g., 50% utilization instead of default 100% utilization.

For instance, the processing circuitry 130 may set a higher XPU power weightage to a processing core frequency or memory bandwidth in case of a compute-focused task (compute-based instance). On the other hand, the processing circuitry 130 may set a higher XPU power weightage to I/O, CXL attach points and network throughput in case of a network-focused task (network bound instance).

XPU flow graph=FUNC(services roster, services compute flow (e.g., a call sequence such as a gRPC (Google remote procedure call), services data flow (precision, format, etc.), emulation capability/limitations)

Function 3, where services roster refers to discovered computing services (software services) available in given platform(s) under consideration, e.g., microservices; services compute flow refers to a call sequence of identified for the identified computing services, e.g., a call sequency flow graph between the identified computing services such as a gRPC call sequence; services data flow refers to a data flow graph between the identified computing services and a corresponding compute flow, e.g., a datatype format (FP32) or precision used for AI inference (INT8); emulation capability/limitations refers to any XPU limitation in terms of hardware acceleration or emulation of future capability (e.g., FP4 precision for AI inference).

XPU QoS=FUNC_TELEMETRY (XPU Compute, XPU Latency, XPU Throughput)

Function 4, where FUNC_TELEMETRY refers to a telemetry monitoring, e.g., of a performance monitoring unit (PMU) which counters across the discovered XPUs in the roster in terms of compute utilization (e.g., 20% or 50%), latency (e.g., in milliseconds), and throughput (in terms of amount of data).

APP SLO=FUNC (XPU options, latency/jitter QoS requirement, power/TCO requirement)

Function 5, where XPU options refers to a choice (resource combination) of XPUs and choice of XPU attributes to be used (e.g., GPU with FP16 support); latency/jitter refers to the application latency requirement (indicated by the SLA) of the platform (computing system 110), e.g., respond to query (request) within 5 ms; power/TCO requirement refers to the platform power constraint or cost constraint the task is expected to have for a given choice of resource combinations.

ML Feedback=FUNC (RL of interaction matrix, policy management, updated weights)

Function 6, where RL of interaction matrix refers to a parameter of a reinforcement learning reward-based mechanism for the ML (machine learning) algorithm to add weightage to a recommendation of a resource combination/configuration; policy management refers to any override for ML inputs; updated weights refer to the deep learning weights to be updated for any model fine-tuning based on real-world scenario/learning.

In the following, the determination of the resources 150, 160 is described in detail:

In some examples, the processing circuitry 130 is further configured to determine a configuration of the computing system 110 indicating a plurality of resources provided by the computing system 110 and determine the at least two resources 150, 160 based on the configuration of the computing system 110 and the SLA. For instance, the processing circuitry 130 may select the at least two resources 150, 160 among the discovered plurality of resources. The latter may enable the apparatus 100 to discover all available resources and therefore improve the selection of the resources 150, 160 in order to comply with the SLA. In some examples, the processing circuitry 130 is further configured to determine a plurality of settings of the resources 150, 160 and select a setting from the plurality of settings based on the SLA.

In some examples, the processing circuitry 130 is further configured to dynamically determine whether the configuration of the computing system 110 has changed and, if it is determined that the configuration of the computing system 110 has changed, redetermine at least two resources (150, 160 and/or other resources) based on the changed configuration of the computing system 110. In the latter examples, the processing circuitry 130 may further be configured to determine an interdependency between the redetermined at least two resources required for the execution of the task based on the SLA and reschedule the execution of the task based on the interdependency between the redetermined at least two resources. This may enable a dynamic discovery of available resources which is especially beneficial in computing environments with changing configurations. For instance, the processing circuitry 130 may be configured to dynamically determine whether the configuration of the computing system 110 has changed by detecting at least one of a hot-plug and an un-plug of a resource of the computing system 110.

The apparatus 100 may provide a discovery module to adjust/adapt the interdependency based on, e.g., hot-plug/un-plug of XPUs, or DIMMs (dual inline memory modules)/storage modules, dynamically. The apparatus 100 may therefore perform platform configuration snapshots at various stages of the platform lifecycle configurable via policies. Any hot plug/un-plug of the XPUs, DIMMs, may trigger the apparatus 100 to profile the platform configuration scan as well as one time at each stage of platform deployment (manufacturing at the original design manufacturer (ODM), provisioning at original equipment manufacturer (OEM), deployment at edge/cloud, etc.). The apparatus 100 may therefore aggregate QoS profiles which are supported by the discovered resources of the computing system 110 (at ingredient XPU, SoC (system on chip), interconnect, storage, networking modules, etc.), e.g., in terms of performance and power capabilities/options. The apparatus 100 may use said aggregation to decide on the best option of resources (and optionally further resources) to be selected for execution of the task. Using the determined ingredient capabilities and the QoS configuration profile, the apparatus 100 may calculate the interdependency flow matrix at a platform level that can sustain the QoS guardrails configured.

The processing circuitry 130 is, in some examples, configured to determine the at least two resources 150, 160 (and optionally settings of the resources 150, 160) by determining, based on the SLA and the configuration of the computing system 110, a plurality of resource combinations for the execution of the task and a respective interdependency between at least two resources of each of the plurality of resource combinations. For instance, the configuration for the computing system 110 may allow for several options of resources and respective settings options to be selected for execution of the task.

In such cases, the processing circuitry 130 may check the resulting interdependencies of the options. The processing circuitry 130 may further be configured to estimate a respective QoS metric achievable by each (or at least one) of the plurality of resource combinations based on the respective interdependency and select a desired resource combination comprising the at least two resources 150, 160 among the plurality of resource combinations based on the estimated QoS metric. For instance, the selection may be done by an optimization mechanism which converges the estimated QoS metric to the SLA requirements.

The estimation of the QoS metric may be done in the following way: The processing circuitry 130 may, in some examples, be configured to determine (estimate) the respective QoS metric achievable by at least one of the plurality of resource combinations by requesting a respective QoS metric from each (or at least one) of the plurality of resources provided by the computing system 110. In some examples, the processing circuitry 130 may estimate the QoS metric achievable by at least one of the plurality of resource combinations by using reinforcement learning. Reinforcement learning may relate to a machine learning mechanism making use of an agent aiming at increasing a reward for correct learning. For instance, the processing circuitry 130 may use the resource (and setting) combination and the monitored telemetry of the resource combination as training data to perform reinforcement learning. Additionally or alternatively, the processing circuitry 130 may use a result from a sandbox testing (as described below) of the resource and setting combination as training data. The QoS metric of a resource combination of the plurality of resource combinations may, for instance, indicate at least one of an estimated latency, an estimated data throughput, an estimated power constraint, and an estimated utilization of resources of the resource combination.

In a complex multitasking computing environment, it may be useful to have a certain degree of freedom for scheduling the execution of the task. Therefore, in some examples, the processing circuitry 130 is configured to estimate a tolerance of the SLA by means of a recommendation engine and select the desired resource combination by determining which of the plurality of resource combinations fulfill the SLA within the tolerance. A recommendation engine or recommender system may be an information filtering system that provide suggestions for items that are most pertinent to a particular user (and thus the task). The processing circuitry 130 may, for instance, analyze and record the task specific requirements to retrieve a tolerance for values (e.g., computing power and/or computing performance) defined in the SLA which may still lead to a high QoS. The processing circuitry 130 may thus estimate a priority or importance of the task to determine the tolerance. For instance, the processing circuitry 130 may be configured to estimate the tolerance of the SLA by applying at least one of collaborative filtering and content-based recommendation to a profile of the task.

Additionally or alternatively, the processing circuitry 130 may filter, by means of a recommendation engine, the resource combination to be selected. For instance, the recommendation engine may, based on a task (or user) profile, select a sufficiently good option among the plurality of resource combinations and settings by limiting the plurality of resource combinations to a subset which is potentially best in terms of QoS for the task. The recommendation engine may therefore increase the speed and improve the result of the decision making.

The recommendation engine may be implemented by a recommender module. The recommender module may—based on the interdependency flow matrix generate by the discovery module for various supported XPU combinations at platform level (example: ID_FM1, ID_FM2, . . . ID_FMN)—help applying collaborative filtering and content-based recommendation (e.g., profile recommender as defined by function 7) to understand and identify the best option in terms of QoS meet and adjust for tolerance profiles to provide recommendation for a given platform XPU combination, e.g., by means of a knowledgebase context mapper as defined by function 8.

profile recommender=FUNC (interaction matrix, knowledgebase context mapper, _algorithm_);

Function 7, where _algorithm_ is, e.g., collaborative or content-based filtering.

knowledgebase context mapper=FUNC_CONTEXT_REG (applications, middleware, services constraints, runtime telemetry)

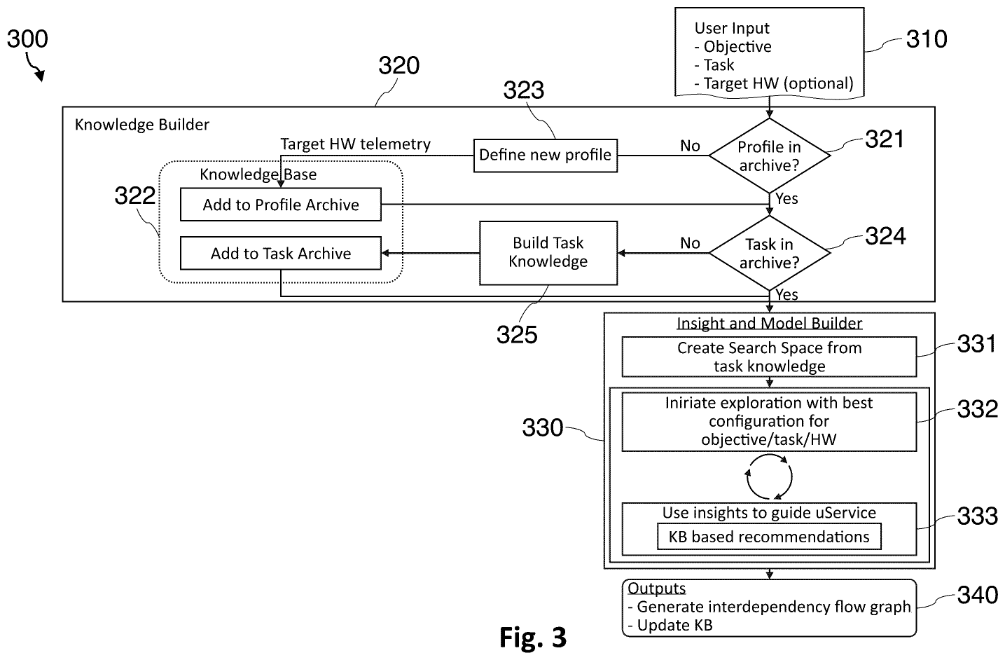

An example of how the resources 150, 160 and their settings can be determined is described with reference to FIG. 3. FIG. 3 illustrates an example of a flowchart of a method 300 for configuring and exploring resources for execution of a task 310. The method 300 may, for instance, be performed by an apparatus as described herein, such as apparatus 100. The task 310 is received as user input and specify an SLA such as an objective and an optional target hardware for execution of the task.

The apparatus 100 comprises a knowledge builder 320: the apparatus 100 checks, in block 321, whether a profile of the task (the objective etc.) is registered in an archive (knowledge base) 322. If not, the apparatus 100 defines, in block 323, a new profile for the task and saves the profile (target hardware telemetry) in the archive 322. If so, the apparatus 100 checks, in block 324, whether the task 310 is registered in the archive 322. If not, the apparatus 100 builds task knowledge in block 325 and saves the task knowledge in the archive 322.

If so, the apparatus 100 proceeds with an insight and model builder 330. In block 331, the apparatus 100 creates a search space (including possible resource and setting combinations for the task 310) from the task knowledge. In block 332, the apparatus 100 initiates exploration for the best configuration (combination) for objective and target hardware of the task 310. In block 333, the apparatus 100 applies a knowledge-based recommendation mechanism (use insights) to select the resources and their settings for execution of the task.

In block 340, the apparatus 100 determines the interdependency between the selected resources with selected settings (generate interdependency flow graph) and updates the knowledgebase, e.g., by associating the selected resource and settings with the task and the task profile.

As mentioned above, sandbox testing may be applied to the at least two resources 150, 160. For instance, the processing circuitry 130 may be configured to determine whether the execution of the task based on the interdependency between the at least two resources 150, 160 fulfills the SLA of the execution of the task by testing the execution of the task in a sandbox environment. The sandbox environment (or working directory, a test server) may emulate the execution of the task by the at least two resources 150, 160 by replicating at least a minimal functionality of the task execution in an isolated environment (isolated from other tasks). For instance, the processing circuitry 130 may use the same settings and resources 150, 160 as intended for execution of the task, but may only make a short test run and monitor the behavior of the resources 150, 160 (e.g., speed, power etc.). Alternatively, the processing circuitry 130 may use a test server with identical settings as intended for the execution of the task.

If it is determined that the execution of the task based on the interdependency between the at least two resources 150, 160 does not fulfill the SLA, the processing circuitry 130 may be configured to redetermine at least one of the interdependency and the at least two resources for execution of the task. Sandboxing may allow to improve the selection of resources and their settings (resource combinations) in order to comply with the SLA. Further, it may provide a protected test environment which does not interfere with already running tasks.

In some examples, the processing circuitry 130 is configured to monitor a QoS metric achieved during an execution of the task based on the interdependency between the at least two resources 150, 160. The apparatus 100 may further comprise memory, e.g., memory 140, to store the monitored QoS metric. The memory may store, e.g., the QoS metric associated with at least one of a profile of the task, the SLA, a user identifier of a user requesting the execution of the task, the resources 150, 160, the settings of the resources 150, 160. The QoS monitoring may improve the estimation of the QoS which can be achieved by the plurality of resources.

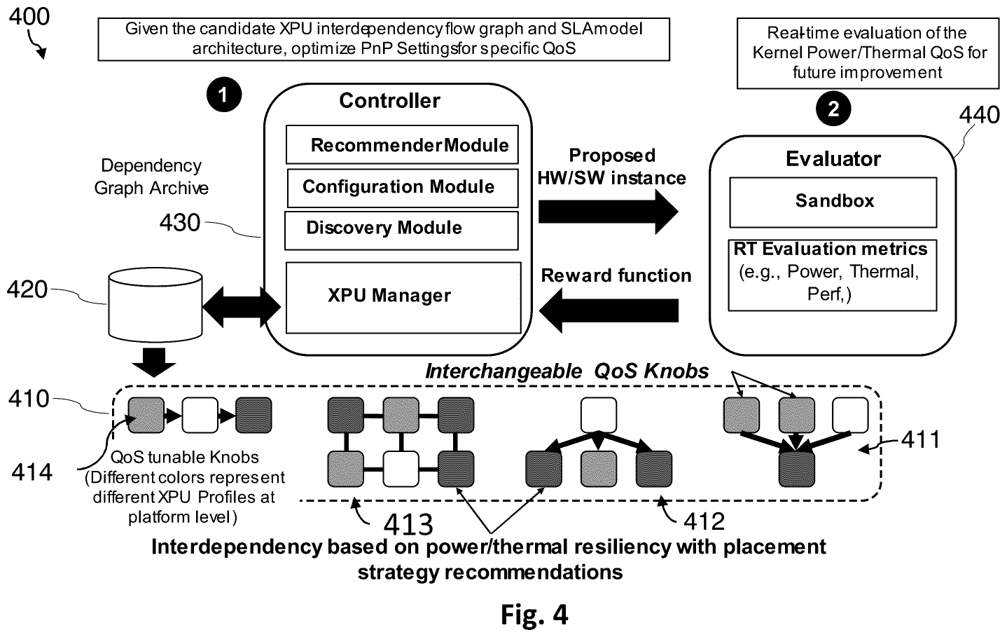

FIG. 4 illustrates an example of a method 400 for selecting a resource combination among a plurality of resource combinations based on a respective interdependency 410. For instance, an apparatus as described herein, such as apparatus 100, may perform one or more steps of the method 400. For illustrative purposes, there are shown four resource combinations 411, 412, 413, 414 and their respective interdependencies in FIG. 4. In other examples, there may be any number of resource combinations n≥1 considered for the execution of a task.

The resource combinations 411, 412, 413, 414 and their interdependencies are illustrated as a respective selection and arrangement of resources and optionally further (shared) resources (both: rectangles). Further, their settings and/or estimated QoS metrics, e.g., estimated utilization, are illustrated by different hatchings (colors). The interconnections of the resources within a resource combination illustrates a data flow (data dependency) between the resources.

The interdependencies 410 are stored in a dependency graph archive 420 (e.g., memory 140). The dependency graph archive 420 is coupled to a controller 430 of the apparatus 100. The controller 430 comprises a recommender module (as described above), a configuration module (as described above), a discovery module (as described above), and an XPU manager (to control the XPUs). The controller 430 may select a candidate resource combination based on an SLA received for execution of a task and optimize the power and performance settings of the selected candidate to achieve a certain QoS for compliance to the SLA. The controller 430 may therefore propose a hardware and software instance to provide a minimum functionality of the candidate resource combination.

An evaluator 440 of the apparatus 100 receives the proposed instance and tests it in a sandbox environment. During testing, the evaluator 440 may monitor real-time evaluation metrics (QoS metrics), e.g., power, thermal or performance metrics. The evaluator 440 may output a reward based on a reward function (of reinforcement learning) based on the monitored QoS metrics. The controller 430 receives the reward and adjusts, if necessary, at least one of the intended resource combinations, the interdependency, the settings of the resources accordingly. The controller 430 further stores the adjusted resource combination, its determined interdependency and settings in the dependency graph archive 420 for future use.

The controller 430 and evaluator 440 (module) may provide the capability to police, monitor, and perform synthetic sandbox evaluation for run-time enforcement of QoS guard rails across variety of configuration involving XPUs, and platform configurations. The evaluator 440 may police whether the secured recommended profile is behaving within the provisioned policies, QoS constraints and take any necessary policy-based actions. Additionally, machine-learning based techniques can be applied for reward-based improvements for future selection of resources, settings and interdependencies, e.g., for future tasks.

For instance, for tackling the challenges of a multitasking environment, the apparatus 100 may handle a plurality of tasks and respective SLAs. In these cases, the apparatus 100 may use the above mentioned stored QoS metric to further improve the resource/setting selection. For example, the interface circuitry 120 may be configured to receive a request to execute a second task on the computing system 110 and receive a second SLA indicating at least one of a desired computing performance and a desired computing power for an execution of the second task by the computing system 110. The processing circuitry 130 may be configured to determine an interdependency between at least two resources (resources 150, 160 or other resources) of the computing system 110 required for the execution of the second task based on the second SLA and the stored QoS metric and schedule the execution of the second task based on the interdependency between the at least two resources.

The apparatus 100 may further exhibit the capability to select centralized or decentralized decision making for selecting the resources 150, 160 and their settings according to the SLA. Centralized decision making may be performed, e.g., via firmware or driver stack running at platform VMM (virtual machine manager). Decentralized decision making may be performed via a decentralized XPU firmware level where each (or at least one) XPU is smart about its contribution to the overall workload flow and can participate in a public ledger (e.g., blockchain) to track the peer-to-peer negotiations or recommendations.

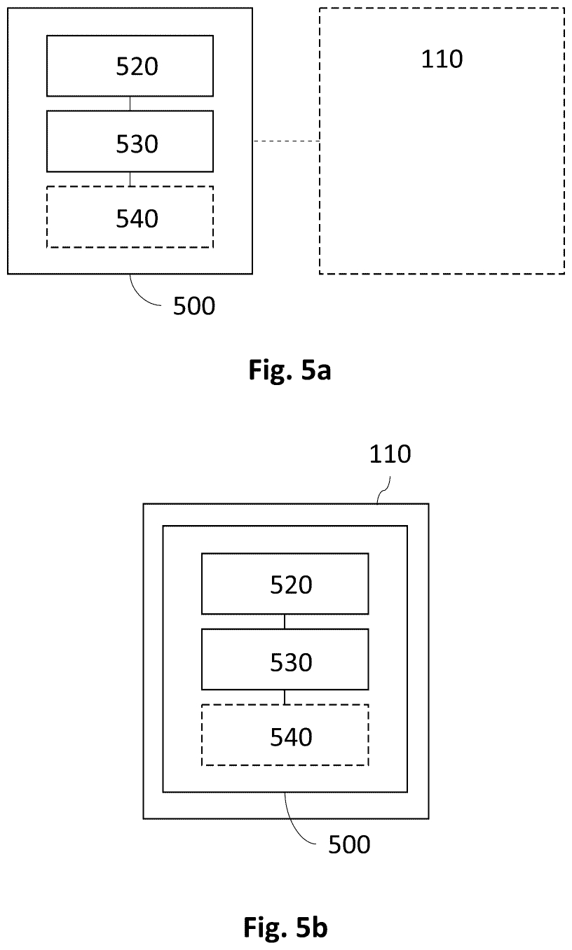

In the following, the said decentralized decision making is explained with reference to FIG. 5a and FIG. 5b. FIG. 5a illustrates a block diagram of an example of an apparatus 500 or device 500 communicatively coupled to the computer system 110. FIG. 5b illustrates a block diagram of an example of a computer system 110 comprising an apparatus 500 or device 500. For instance, the apparatus 500 may be integrated into a resource of the computing system 110, such as resource 150 or 160 introduced above.

The apparatus 500 comprises circuitry that is configured to provide the functionality of the apparatus 500. For example, the apparatus 500 of FIGS. 5a and 5b comprises interface circuitry 520, processing circuitry 530 and (optional) storage circuitry 540. For example, the processing circuitry 530 may be coupled with the interface circuitry 520 and with the storage circuitry 540.

For example, the processing circuitry 530 may be configured to provide the functionality of the apparatus 500, in conjunction with the interface circuitry 520 (for exchanging information, e.g., with other components inside or outside the computer system 110) and the storage circuitry 540 (for storing information, such as machine-readable instructions).

Likewise, the device 500 may comprise means that is/are configured to provide the functionality of the device 500.

The components of the device 500 are defined as component means, which may correspond to, or implemented by, the respective structural components of the apparatus 500. For example, the device 500 of FIGS. 5a and 5b comprises means for processing 530, which may correspond to or be implemented by the processing circuitry 530, means for communicating 520, which may correspond to or be implemented by the interface circuitry 520, and (optional) means for storing information 540, which may correspond to or be implemented by the storage circuitry 540. In the following, the functionality of the device 500 is illustrated with respect to the apparatus 500. Features described in connection with the apparatus 500 may thus likewise be applied to the corresponding device 500.

In general, the functionality of the processing circuitry 530 or means for processing 530 may be implemented by the processing circuitry 530 or means for processing 530 executing machine-readable instructions. Accordingly, any feature ascribed to the processing circuitry 530 or means for processing 530 may be defined by one or more instructions of a plurality of machine-readable instructions. The apparatus 500 or device 500 may comprise the machine-readable instructions, e.g., within the storage circuitry 540 or means for storing information 540.

The interface circuitry 520 is configured to receive a request to determine a QoS metric achievable by a resource of the computing system 110 for execution of a task by the computing system 110 and receive an SLA indicating at least one of a desired computing performance and a desired computing power for an execution of the task by the computing system 110. The processing circuitry 530 is configured to determine the QoS metric based on the SLA. For instance, the processing circuitry 530 may be configured to determine the QoS metric by negotiating the QoS metric with a plurality of resources of the computing system 110. The processing circuitry 530 may further be configured to store the QoS metric on a distributed ledger accessible by a plurality of resources of the computing system 110, e.g., for performing the above negotiations.

The apparatus 500 may provide a decentralized decision-making for selecting resources and of the computing system 110, their settings and interdependencies for compliance to a predefined computing power and/or performance indicated by the SLA. The apparatus 500 may increase the reliability of the decision-making by providing multiple nodes contributing to the decision and improve the achievable QoS for a task by bidding and negotiating resources.

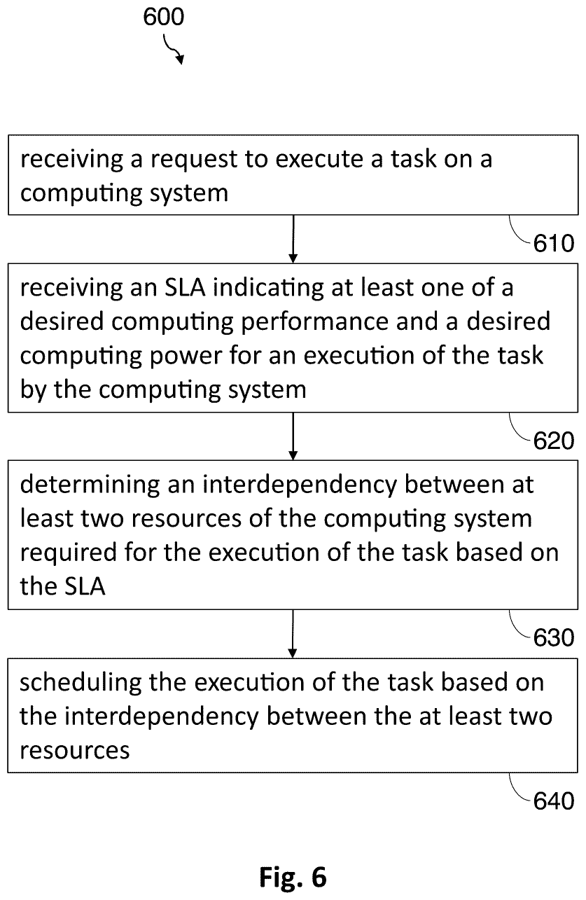

FIG. 6 illustrates an example of a (computer-implemented) method 600. For instance, the method 600 may be performed by an apparatus as described herein, such as apparatus 100.

The method 600 comprises receiving 610 a request to execute a task on a computing system, receiving 620 an SLA indicating at least one of a desired computing performance and a desired computing power for an execution of the task by the computing system and determining 630 an interdependency between at least two resources of the computing system required for the execution of the task based on the SLA. The method 600 further comprises scheduling 640 the execution of the task based on the interdependency between the at least two resources.

More details and aspects of the method 600 are explained in connection with the proposed technique or one or more examples described above (e.g., FIGS. 1 to 4). The method 600 may comprise one or more additional optional features corresponding to one or more aspects of the proposed technique, or one or more examples described above.

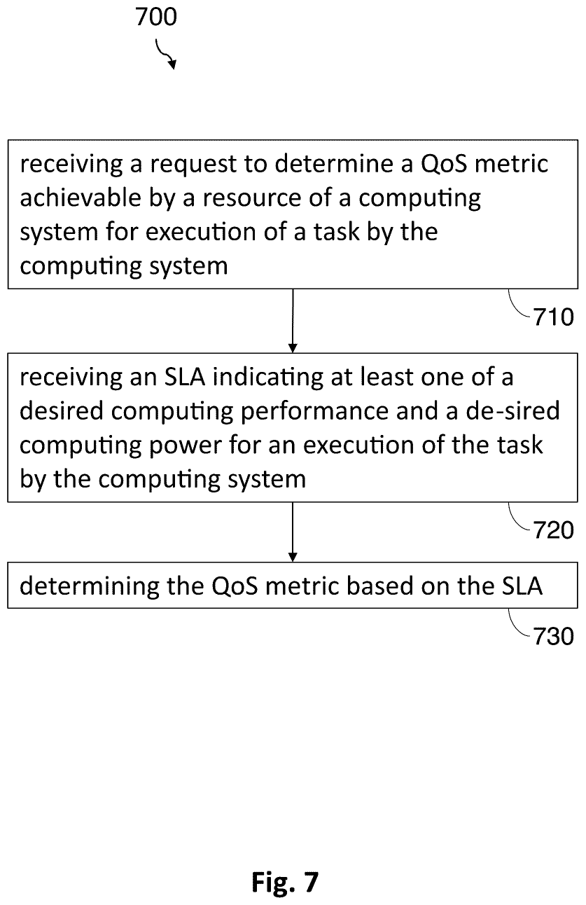

FIG. 7 illustrates an example of a (computer-implemented) method 700. For instance, the method 700 may be performed by an apparatus as described herein, such as apparatus 500.

The method 700 comprises receiving 710 a request to determine a QoS metric achievable by a resource of a computing system for execution of a task by the computing system, receiving 720 an SLA indicating at least one of a desired computing performance and a desired computing power for an execution of the task by the computing system and determining 730 the QoS metric based on the SLA.

More details and aspects of the method 700 are explained in connection with the proposed technique or one or more examples described above (e.g., FIG. 5). The method 700 may comprise one or more additional optional features corresponding to one or more aspects of the proposed technique, or one or more examples described above.

Methods and apparatuses described herein may provide a dynamic XPU QoS-based sustainable power management for DCoF (data center of the future) customers.

In the following, some examples of the proposed technique are presented:
An example (e.g., example 1) relates to an apparatus, the apparatus comprising interface circuitry, machine-readable instructions, and processing circuitry to execute the machine-readable instructions to receive a request to execute a task on a computing system, receive a service-level agreement, SLA, indicating at least one of a desired computing performance and a desired computing power for an execution of the task by the computing system, determine an interdependency between at least two resources of the computing system required for the execution of the task based on the SLA, and schedule the execution of the task based on the interdependency between the at least two resources.
Another example (e.g., example 2) relates to a previous example (e.g., example 1) or to any other example, further comprising that the at least two resources are processing units exhibiting different architectures.
Another example (e.g., example 3) relates to a previous example (e.g., one of the examples 1 or 2) or to any other example, further comprising that the at least two resources comprise at least one of a central processing unit, a graphics processing unit, a field-programmable gate array, and an accelerator.
Another example (e.g., example 4) relates to a previous example (e.g., one of the examples 1 to 3) or to any other example, further comprising that the instructions comprise instructions to determine the interdependency between the at least two resources by determining a desired respective utilization of each of the at least two resources based on the SLA.
Another example (e.g., example 5) relates to a previous example (e.g., one of the examples 1 to 4) or to any other example, further comprising that the instructions comprise instructions to determine the interdependency between the at least two resources by determining an interoperability between the at least two resources.
Another example (e.g. example 6) relates to a previous example (e.g., one of the examples 1 to 5) or to any other example, further comprising that the instructions comprise instructions to determine the interdependency between the at least two resources by determining at least one further resource of the computing system shared by the at least two resources required for the execution of the task.
Another example (e.g., example 7) relates to a previous example (e.g., example 6) or to any other example, further comprising that the instructions comprise instructions to determine the at least one further resource by determining at least one of a memory bandwidth and a network bandwidth shared by the at least two resources.
Another example (e.g., example 8) relates to a previous example (e.g., one of the examples 1 to 7) or to any other example, further comprising that the instructions comprise instructions to determine the interdependency between the at least two resources by determining a data dependency between the at least two resources.
Another example (e.g., example 9) relates to a previous example (e.g., example 8) or to any other example, further comprising that the instructions comprise instructions to determine the data dependency between the at least two resources by determining at least one of an availability of computing services of the computing system and a call sequence of the task.
Another example (e.g., example 10) relates to a previous example (e.g., one of the examples 1 to 9) or to any other example, further comprising that the instructions comprise instructions to determine a configuration of the computing system indicating a plurality of resources provided by the computing system, and determine the at least two resources based on the configuration of the computing system and the SLA.
Another example (e.g., example 11) relates to a previous example (e.g., example 10) or to any other example, further comprising that the instructions comprise instructions to dynamically determine whether the configuration of the computing system has changed, and if it is determined that the configuration of the computing system has changed, redetermine at least two resources based on the changed configuration of the computing system, determine an interdependency between the redetermined at least two resources required for the execution of the task based on the SLA, and reschedule the execution of the task based on the interdependency between the redetermined at least two resources.
Another example (e.g., example 12) relates to a previous example (e.g., example 11) or to any other example, further comprising that the instructions comprise instructions to dynamically determine whether the configuration of the computing system has changed by detecting at least one of a hot-plug and an un-plug of a resource of the computing system.
Another example (e.g., example 13) relates to a previous example (e.g., one of the examples 10 to 12) or to any other example, further comprising that the instructions comprise instructions to determine the at least two resources by determining, based on the SLA and the configuration of the computing system, a plurality of resource combinations for the execution of the task and a respective interdependency between at least two resources of each of the plurality of resource combinations, estimating a respective quality of service, QoS, metric achievable by each of the plurality of resource combinations based on the respective interdependency, and selecting a desired resource combination comprising the at least two resources among the plurality of resource combinations based on the estimated QoS metric.
Another example (e.g., example 14) relates to a previous example (e.g., example 13) or to any other example, further comprising that the instructions comprise instructions to estimate a tolerance of the SLA by means of a recommendation engine, and select the desired resource combination by determining which of the plurality of resource combinations fulfill the SLA within the tolerance.
Another example (e.g., example 15) relates to a previous example (e.g., example 14) or to any other example, further comprising that the instructions comprise instructions to estimate the tolerance of the SLA by applying at least one of collaborative filtering and content-based recommendation to a profile of the task.
Another example (e.g., example 16) relates to a previous example (e.g., one of the examples 13 to 15) or to any other example, further comprising that the instructions comprise instructions to determine the respective QoS metric achievable by at least one of the plurality of resource combinations by requesting a respective QoS metric from each of the plurality of resources provided by the computing system.
Another example (e.g., example 17) relates to a previous example (e.g., one of the examples 13 to 16) or to any other example, further comprising that the instructions comprise instructions to estimate the QoS metric achievable by at least one of the plurality of resource combinations by using reinforcement learning.
Another example (e.g., example 18) relates to a previous example (e.g., one of the examples 13 to 17) or to any other example, further comprising that the QoS metric of a resource combination of the plurality of resource combinations indicates at least one of an estimated latency, an estimated data throughput, an estimated power constraint, and an estimated utilization of resources of the resource combination.
Another example (e.g., example 19) relates to a previous example (e.g., one of the examples 1 to 18) or to any other example, further comprising that the instructions comprise instructions to determine whether the execution of the task based on the interdependency between the at least two resources fulfills the SLA of the execution of the task by testing the execution of the task in a sandbox environment, and if it is determined that the execution of the task based on the interdependency between the at least two resources does not fulfill the SLA, redetermine at least one of the interdependency and the at least two resources for execution of the task.
Another example (e.g., example 20) relates to a previous example (e.g., one of the examples 1 to 19) or to any other example, further comprising that the instructions comprise instructions to monitor a QoS metric achieved during an execution of the task based on the interdependency between the at least two resources, wherein the apparatus further comprises memory to store the monitored QoS metric.
Another example (e.g., example 21) relates to a previous example (e.g., example 20) or to any other example, further comprising that the instructions comprise instructions to receive a request to execute a second task on the computing system, receive a second SLA indicating at least one of a desired computing performance and a desired computing power for an execution of the second task by the computing system, determine an interdependency between at least two resources of the computing system required for the execution of the second task based on the second SLA and the stored QoS metric, and schedule the execution of the second task based on the interdependency between the at least two resources.
An example (e.g., example 22) relates to an apparatus, the apparatus comprising interface circuitry, machine-readable instructions, and processing circuitry to execute the machine-readable instructions to receive a request to determine a quality of service, QoS, metric achievable by a resource of a computing system for execution of a task by the computing system, receive a service-level agreement, SLA, indicating at least one of a desired computing performance and a desired computing power for an execution of the task by the computing system, and determine the QoS metric based on the SLA.
Another example (e.g., example 23) relates to a previous example (e.g., example 22) or to any other example, further comprising that the instructions comprise instructions to store the QoS metric on a distributed ledger accessible by a plurality of resources of the computing system.
Another example (e.g., example 24) relates to a previous example (e.g., one of the examples 22 or 23) or to any other example, further comprising that the instructions comprise instructions to determine the QoS metric by negotiating the QoS metric with a plurality of resources of the computing system.
An example (e.g., example 25) relates to a method, comprising receiving a request to execute a task on a computing system, receiving a service-level agreement, SLA, indicating at least one of a desired computing performance and a desired computing power for an execution of the task by the computing system, determining an interdependency between at least two resources of the computing system required for the execution of the task based on the SLA, and scheduling the execution of the task based on the interdependency between the at least two resources.
Another example (e.g., example 26) relates to a previous example (e.g., example 25) or to any other example, further comprising that determining the interdependency between the at least two resources comprises determining a desired respective utilization of each of the at least two resources based on the SLA.
An example (e.g., example 27) relates to a method, comprising receiving a request to determine a quality of service, QoS, metric achievable by a resource of a computing system for execution of a task by the computing system, receiving a service-level agreement, SLA, indicating at least one of a desired computing performance and a desired computing power for an execution of the task by the computing system, and determining the QoS metric based on the SLA.
Another example (e.g., example 28) relates to a previous example (e.g., example 27) or to any other example, further comprising storing the QoS metric on a distributed ledger accessible by a plurality of resources of the computing system.
Another example (e.g., example 29) relates to a non-transitory machine-readable storage medium including program code, when executed, to cause a machine to perform the method of a previous example (e.g. any one of examples 25 or 26) or any other example.
Another example (e.g., example 30) relates to a non-transitory machine-readable storage medium including program code, when executed, to cause a machine to perform the method of a previous example (e.g., any one of examples 27 or 28) or any other example.
An example (e.g., example 31) relates to an apparatus, the apparatus comprising interface circuitry configured to receive a request to execute a task on a computing system and receive a service-level agreement, SLA, indicating at least one of a desired computing performance and a desired computing power for an execution of the task by the computing system, the apparatus further comprising processing circuitry configured to determine an interdependency between at least two resources of the computing system required for the execution of the task based on the SLA, and schedule the execution of the task based on the interdependency between the at least two resources.
Another example (e.g., example 32) relates to a previous example (e.g., example 31) or to any other example, further comprising that the at least two resources are processing units exhibiting different architectures.
Another example (e.g., example 33) relates to a previous example (e.g., one of the examples 31 or 32) or to any other example, further comprising that the at least two resources comprise at least one of a central processing unit, a graphics processing unit, a field-programmable gate array, and an accelerator.
Another example (e.g., example 34) relates to a previous example (e.g., one of the examples 31 to 33) or to any other example, further comprising that the processing circuitry is configured to determine the interdependency between the at least two resources by determining a desired respective utilization of each of the at least two resources based on the SLA.
Another example (e.g., example 35) relates to a previous example (e.g., one of the examples 31 to 34) or to any other example, further comprising that the processing circuitry is configured to determine the interdependency between the at least two resources by determining an interoperability between the at least two resources.
Another example (e.g., example 36) relates to a previous example (e.g., one of the examples 31 to 35) or to any other example, further comprising that the processing circuitry is configured to determine the interdependency between the at least two resources by determining at least one further resource of the computing system shared by the at least two resources required for the execution of the task.
Another example (e.g., example 37) relates to a previous example (e.g., example 36) or to any other example, further comprising that the processing circuitry is configured to determine the at least one further resource by determining at least one of a memory bandwidth and a network bandwidth shared by the at least two resources.
Another example (e.g., example 38) relates to a previous example (e.g., one of the examples 31 to 37) or to any other example, further comprising that the processing circuitry is configured to determine the interdependency between the at least two resources by determining a data dependency between the at least two resources.
Another example (e.g., example 39) relates to a previous example (e.g., example 38) or to any other example, further comprising that the processing circuitry is configured to determine the data dependency between the at least two resources by determining at least one of an availability of computing services of the computing system and a call sequence of the task.
Another example (e.g., example 40) relates to a previous example (e.g., one of the examples 31 to 39) or to any other example, further comprising that the processing circuitry is configured determine a configuration of the computing system indicating a plurality of resources provided by the computing system, and determine the at least two resources based on the configuration of the computing system and the SLA.
Another example (e.g., example 41) relates to a previous example (e.g., example 40) or to any other example, further comprising that the processing circuitry is configured dynamically determine whether the configuration of the computing system has changed, and if it is determined that the configuration of the computing system has changed, redetermine at least two resources based on the changed configuration of the computing system, determine an interdependency between the redetermined at least two resources required for the execution of the task based on the SLA, and reschedule the execution of the task based on the interdependency between the redetermined at least two resources.
Another example (e.g., example 42) relates to a previous example (e.g., example 41) or to any other example, further comprising that the processing circuitry is configured to dynamically determine whether the configuration of the computing system has changed by detecting at least one of a hot-plug and an un-plug of a resource of the computing system.
Another example (e.g., example 43) relates to a previous example (e.g., one of the examples to 42) or to any other example, further comprising that the processing circuitry is configured to determine the at least two resources by determining, based on the SLA and the configuration of the computing system, a plurality of resource combinations for the execution of the task and a respective interdependency between at least two resources of each of the plurality of resource combinations, estimating a respective quality of service, QoS, metric achievable by each of the plurality of resource combinations based on the respective interdependency, and selecting a desired resource combination comprising the at least two resources among the plurality of resource combinations based on the estimated QoS metric.
Another example (e.g., example 44) relates to a previous example (e.g., example 43) or to any other example, further comprising that the processing circuitry is configured to estimate a tolerance of the SLA by means of a recommendation engine, and select the desired resource combination by determining which of the plurality of resource combinations fulfill the SLA within the tolerance.
Another example (e.g., example 45) relates to a previous example (e.g., example 44) or to any other example, further comprising that the processing circuitry is configured to estimate the tolerance of the SLA by applying at least one of collaborative filtering and content-based recommendation to a profile of the task.
Another example (e.g., example 46) relates to a previous example (e.g., one of the examples 43 to 45) or to any other example, further comprising that the processing circuitry is configured to determine the respective QoS metric achievable by at least one of the plurality of resource combinations by requesting a respective QoS metric from each of the plurality of resources provided by the computing system.
Another example (e.g., example 47) relates to a previous example (e.g., one of the examples 43 to 46) or to any other example, further comprising that the processing circuitry is configured to estimate the QoS metric achievable by at least one of the plurality of resource combinations by using reinforcement learning.
Another example (e.g., example 48) relates to a previous example (e.g., one of the examples 43 to 47) or to any other example, further comprising that the QoS metric of a resource combination of the plurality of resource combinations indicates at least one of an estimated latency, an estimated data throughput, an estimated power constraint, and an estimated utilization of resources of the resource combination.
Another example (e.g., example 49) relates to a previous example (e.g., one of the examples 31 to 48) or to any other example, further comprising that the processing circuitry is configured to determine whether the execution of the task based on the interdependency between the at least two resources fulfills the SLA of the execution of the task by testing the execution of the task in a sandbox environment, and if it is determined that the execution of the task based on the interdependency between the at least two resources does not fulfill the SLA, redetermine at least one of the interdependency and the at least two resources for execution of the task.
Another example (e.g., example 50) relates to a previous example (e.g., one of the examples 31 to 49) or to any other example, further comprising that the processing circuitry is configured to monitor a QoS metric achieved during an execution of the task based on the interdependency between the at least two resources, wherein the apparatus further comprises memory to store the monitored QoS metric.
Another example (e.g., example 51) relates to a previous example (e.g., example 50) or to any other example, further comprising that the interface circuitry is configured to receive a request to execute a second task on the computing system and receive a second SLA indicating at least one of a desired computing performance and a desired computing power for an execution of the second task by the computing system, the processing circuitry being configured to determine an interdependency between at least two resources of the computing system required for the execution of the second task based on the second SLA and the stored QoS metric, and schedule the execution of the second task based on the interdependency between the at least two resources.
An example (e.g., example 52) relates to an apparatus, the apparatus comprising interface circuitry configured to receive a request to determine a quality of service, QoS, metric achievable by a resource of a computing system for execution of a task by the computing system and receive a service-level agreement, SLA, indicating at least one of a desired computing performance and a desired computing power for an execution of the task by the computing system, the apparatus further comprising processing circuitry configured to determine the QoS metric based on the SLA.
Another example (e.g., example 53) relates to a previous example (e.g., example 52) or to any other example, further comprising that the processing circuitry is configured to store the QoS metric on a distributed ledger accessible by a plurality of resources of the computing system.
Another example (e.g., example 54) relates to a previous example (e.g., one of the examples 52 or 53) or to any other example, further comprising that the processing circuitry is configured to determine the QoS metric by negotiating the QoS metric with a plurality of resources of the computing system.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus, the apparatus comprising interface circuitry, machine-readable instructions, and processing circuitry to execute the machine-readable instructions to:
receive a request to execute a task on a computing system;
receive a service-level agreement, SLA, indicating at least one of a desired computing performance and a desired computing power for an execution of the task by the computing system;
determine an interdependency between at least two resources of the computing system required for the execution of the task based on the SLA; and
schedule the execution of the task based on the interdependency between the at least two resources.

2. The apparatus of claim 1, wherein the at least two resources are processing units exhibiting different architectures.

3. The apparatus of claim 1, wherein the at least two resources comprise at least one of a central processing unit, a graphics processing unit, a field-programmable gate array, and an accelerator.

4. The apparatus of claim 1, wherein the instructions comprise instructions to determine the interdependency between the at least two resources by determining a desired respective utilization of each of the at least two resources based on the SLA.

5. The apparatus of claim 1, wherein the instructions comprise instructions to determine the interdependency between the at least two resources by determining an interoperability between the at least two resources.

6. The apparatus of claim 1, wherein the instructions comprise instructions to determine the interdependency between the at least two resources by determining at least one further resource of the computing system shared by the at least two resources required for the execution of the task.

7. The apparatus of claim 6, wherein the instructions comprise instructions to determine the at least one further resource by determining at least one of a memory bandwidth and a network bandwidth shared by the at least two resources.

8. The apparatus of claim 1, wherein the instructions comprise instructions to determine the interdependency between the at least two resources by determining a data dependency between the at least two resources.

9. The apparatus of claim 8, wherein the instructions comprise instructions to determine the data dependency between the at least two resources by determining at least one of an availability of computing services of the computing system and a call sequence of the task.

10. The apparatus of claim 1, wherein the instructions comprise instructions to:
determine a configuration of the computing system indicating a plurality of resources provided by the computing system; and
determine the at least two resources based on the configuration of the computing system and the SLA.

11. The apparatus of claim 10, wherein the instructions comprise instructions to:
dynamically determine whether the configuration of the computing system has changed; and
if it is determined that the configuration of the computing system has changed, redetermine at least two resources based on the changed configuration of the computing system;
determine an interdependency between the redetermined at least two resources required for the execution of the task based on the SLA; and
reschedule the execution of the task based on the interdependency between the redetermined at least two resources.

12. The apparatus of claim 11, wherein the instructions comprise instructions to dynamically determine whether the configuration of the computing system has changed by detecting at least one of a hot-plug and an un-plug of a resource of the computing system.

13. The apparatus of claim 12, wherein the instructions comprise instructions to determine the at least two resources by:
determining, based on the SLA and the configuration of the computing system, a plurality of resource combinations for the execution of the task and a respective interdependency between at least two resources of each of the plurality of resource combinations;
estimating a respective quality of service, QoS, metric achievable by each of the plurality of resource combinations based on the respective interdependency; and
selecting a desired resource combination comprising the at least two resources among the plurality of resource combinations based on the estimated QoS metric.

14. The apparatus of claim 13, wherein the instructions comprise instructions to:
estimate a tolerance of the SLA by means of a recommendation engine; and
select the desired resource combination by determining which of the plurality of resource combinations fulfill the SLA within the tolerance.

15. The apparatus of claim 14, wherein the instructions comprise instructions to estimate the tolerance of the SLA by applying at least one of collaborative filtering and content-based recommendation to a profile of the task.

16. The apparatus of claim 15, wherein the instructions comprise instructions to determine the respective QoS metric achievable by at least one of the plurality of resource combinations by requesting a respective QoS metric from each of the plurality of resources provided by the computing system.

17. The apparatus of claim 16, wherein the instructions comprise instructions to estimate the QoS metric achievable by at least one of the plurality of resource combinations by using reinforcement learning.

18. The apparatus of claim 1, wherein the instructions comprise instructions to:
determine whether the execution of the task based on the interdependency between the at least two resources fulfills the SLA of the execution of the task by testing the execution of the task in a sandbox environment; and
if it is determined that the execution of the task based on the interdependency between the at least two resources does not fulfill the SLA, redetermine at least one of the interdependency and the at least two resources for execution of the task.

19. An apparatus, the apparatus comprising interface circuitry, machine-readable instructions, and processing circuitry to execute the machine-readable instructions to:
receive a request to determine a quality of service, QoS, metric achievable by a resource of a computing system for execution of a task by the computing system;
receive a service-level agreement, SLA, indicating at least one of a desired computing performance and a desired computing power for an execution of the task by the computing system; and
determine the QoS metric based on the SLA.

20. The apparatus of claim 19, wherein the instructions comprise instructions to store the QoS metric on a distributed ledger accessible by a plurality of resources of the computing system.

21. The apparatus of claim 19, wherein the instructions comprise instructions to determine the QoS metric by negotiating the QoS metric with a plurality of resources of the computing system.

22. A method, comprising:
receiving a request to execute a task on a computing system;
receiving a service-level agreement, SLA, indicating at least one of a desired computing performance and a desired computing power for an execution of the task by the computing system;
determining an interdependency between at least two resources of the computing system required for the execution of the task based on the SLA; and
scheduling the execution of the task based on the interdependency between the at least two resources.

23. The method of claim 22, wherein determining the interdependency between the at least two resources comprises determining a desired respective utilization of each of the at least two resources based on the SLA.

24. A method, comprising:
receiving a request to determine a quality of service, QoS, metric achievable by a resource of a computing system for execution of a task by the computing system;
receiving a service-level agreement, SLA, indicating at least one of a desired computing performance and a desired computing power for an execution of the task by the computing system; and
determining the QoS metric based on the SLA.

25. The method of claim 24, further comprising storing the QoS metric on a distributed ledger accessible by a plurality of resources of the computing system.
